(19) United States
(12) Patent Application Publication
(10) Pub. No.: US 2015/0215288 A1
(43) Pub. Date: Jul. 30, 2015

(54) DECENTRALIZED PEER-BASED INDIRECT AUTHENTICATION METHOD FOR PERSONAL ONLINE SOCIAL NETWORKING PROFILES

(71) Applicant: Kevin R. Ramsaur, Newport Beach, CA (US)

(72) Inventor: Kevin R. Ramsaur, Newport Beach, CA (US)

(21) Appl. No.: 14/166,836

(22) Filed: Jan. 28, 2014

(51) Int. Cl. H04L 29/06

(52) U.S. Cl. CPC H04L 63/0421; H04L 63/10

(57) ABSTRACT

The invention here is a website addressing false profiles confronting online personal social networking systems via an indirect authentication system that relies on existing, scrutinized profiles which in turn acknowledge the authentication of a remote profile under scrutiny. The user's intimate knowledge of their social network enhances effectiveness. System allows registrants to create a profile and obtain a social identity code as a public identifier. The system integrates a virtual wallet to synthesize their online profiles and registrant controls access to it. The user may offer those profiles to be acknowledged by their connections. Once acknowledged, a hyperlink to the acknowledger's profile is created for cross referencing. The system offers an “authenticity index” for users to base their own verification needs. The scrutinizing party can thus make their own “gut-check” determination of the profile. Registrants can then create secure communities for exclusive networking.

### CROSS-REFERENCE TO RELATED APPLICATIONS

This application claims the benefit of provisional patent application No. 61/757,230 filed 2013, Jan. 28 by the present inventor.

### BACKGROUND

### Prior Art

The following is as tabulation of some prior art that presently appears relevant:

U.S. Patents

| Pat. No. | Kind Code | Issue Date | Patentee |
|---|---|---|---|
| 8,010,460 | A1 | 2011-08-30 | Work, et al. |
| 8,010,459 | A1 | 2011-08-30 | Buyukkokten et al. |

### NonPatent Literature Documents

Seigneur, Jean-Mare Seigneur; Gray, Alan; and Damsgaard Jensen, Christian, (http://www.springerlink.com/openurl.asp?genre=article&id=doi:10.1007/11429760_{—}22) “Trust Transfer: Encouraging Self-Recommendations without Sybil Attack” (May 2005)
Douceur R., John (http://research.microsoft.com/en-us/people/johndo/publications.aspx) Proceedings of 1st International Workshop on Peer-to-Peer Systems (IPTPS) “The Sybil Attack” (2002)

### FEDERALLY SPONSORED RESEARCH

NONE

### GENERAL SUMMARY

In its most basic description, the present invention comprises of an internet website and accompanying application of an individual software program (hereinafter, referred to collectively as the “App”. The term App includes and encompasses the related website and software applications for smartphone devices, tablet devices and any other computerized electronic device that is tied into and can utilize the operative features of this business method). The App operates through computerized devices accessing the world-wide web or internet (hereinafter “internet”). This App provides internet users engaged in online social personal networking a unique decentralized and effective system to scrutinize and authenticate online personal networking profiles for their veracity.

This peer-to-peer based system authenticates personal profiles by way of an acknowledgment from their peers and is not designed to gauge the veracity of the content itself but takes content into account as a factor towards authenticity of the profile. For the purposes of this inventions, a registrant can include a person, and entity (such as a corporation or trust) or software. The system integrates a social identity code assigned to each registrant as a means of public identification. This social identity code provides anonymity for the member who registered with the App unless he or she solicits another social network participant for authentication or invites them to access his or her account details. The system also integrates a “virtual wallet” that contains, most prominently, all of the social networking profiles registrant wishes to add to his or her account for acknowledgment and authentication scrutiny by invite. Additionally, the system provides an authenticity metric (hereinafter, “authenticity index”) that includes information put forth in the online social profile networks for visitors or registrants to determine if the real life attributes of the person behind the profile reconcile to their satisfaction. Two versions of the authenticity index are availed. One is a “cursory” version, viewable in the registrant's publicly revealed screen page. The other is the full version containing authenticity and biometric detail accessible by invite in registrant's virtual wallet. In addition, with full access to the authenticity index in its form in the virtual wallet, it can be used to authenticate the source of the social information with the complete use of the system. This is useful for a scrutinizing party because the index consolidates the information as an easy to understand metric for the quality and quantity of the information providing a starting point for a user to begin the manual process of further verification.

This invention is not focused on the sign on aspects of social networking, such as purporting to be a single sign-on solution, but instead seeks to augment existing single sign-on systems that develop to their popularity or ubiquity.

The system is developed to address the problems false profiles pose to online personal social networking systems, but can be adopted to address the problem fake profiles pose in other online realms such as chat rooms and the comment pages of online articles. The social identity code facilitates a quick reference for a scrutinizer confronting a false profile in any of the following forums, social networking, chat room or comments pages of online articles. Ideally, the social identity code will tie in the registrant's authenticity index for useful quick reference through a simple click of the link to the social identity code used as an identifier. This simple reference, will ideally affirm a general assumption that the party engaging in the comments section of online articles, in social networking or a chat room is communicating with their “go to” profile that indicates he has invested a substantial amount of human labor into. Other identifiers apart from the acknowledgments or connections, such as physical devices connected to the social identity code for the profile create authenticating value to the code and profile that is quickly verifiable. These tangible or personal assets such as a cell phone or a verification of the type of vehicle the registrant drives create further verifiable authenticity factors.

In sum, this system incorporates a unique method providing an employable and flexible measure of authentication for the veracity of personal online profiles in relation to the real life attributes of the people behind these profiles and the profile scrutinizer's preferences or needs.

### Background of the False Profile Problem Addressed by the Invention

One or more aspects have the advantages via a decentralized peer based method and system for providing online profile authentication services. Because there exists a casual mindset in relation to online social networking, scrutiny is lax and there exists tangible and documented peril that people engage in personal social networking for dishonest or nefarious reasons. This issue is well chronicled. This ulterior engagement is frequently accomplished by creation of false profiles. These types of users manipulate these sites for reasons ranging from posting vile and offensive content on comments pages for online articles, to outright fraud and committing sex crimes via social network and dating sites. A common time consuming, cumbersome and generally ineffective method of authenticating online profiles is to manually reverse engineer the authentication of the profile (If one is allowed enough access to the private settings in it by scrutinizing, among other things, the creation date, the content in it and amount of “friends” or social connections linked to the profile and manually cross checking their veracity.

### SPECIFICATION

This system prominently incorporates the “acknowledgment” system for authentication of online personal social networking profiles. Subsequent to registering with the website and adding social networking profiles content into their virtual wallet, registrant in turn may solicit connections to their online social networks to acknowledge that the contents in their account and virtual wallet reconciles with the real life attributes (or offline evidence) of the registrant. The system simply asks the acknowledgers to indicate basic information with one value: True. Thus, only one value is operative: True. The other possible value is “Null”. “Null” does not have to be displayed (for variety of reasons not relevant to this patent application). Not having a True does not leave an implied false in this system, but is merely an indication that among other things, the connection was not solicited, the connection may not be familiar with the current real life attributes of that person, or the connection does not wish to register with this site, etc. . . . . This component of the system exists in the form of an acknowledgment button for the App user to click to indicate that they know the profile and its creator and that the profile reconciles with the offline evidence of the profile creator's personal attributes.

Additionally, this system incorporates the use of a social identity code (likely to be deemed the “social identity number” or a like marketable term) as the initial identifier for the public page or screen of each registrant's profile. This code is designed to protect the privacy of the registrants from public view. A party wishing to obtain further scrutiny must be invited into the personal identifying details and content of the registrant's profile by the registrant. The social identity code is displayed prominently on the registrant's publicly accessible page or screen, along with the inaccessible version of the authenticity index that merely displays the factors or “credential tokens” for authenticity such as amount of acknowledgements, the profiles added into the virtual wallet, optional identifiers such as profile creator's geographic location, gender, and a general identifying factor such as “student”, employment title or other general identifying feature such as “surfer”, “artist”, “athlete”, etc. . . . .

Thus, detailed personal information will not be displayed on the registrant's public page, only the social identity number and inaccessible authenticity index factors and general identifiers. Registrant may add a personalized avatar or even his or her real name on the public page (ideal for “celebrities” or public figures). Registrant's will also be availed the option keep their general identifying factors private on the public page.

The invitation allowing private access into the virtual wallet of the registrant's profile, essentially acts as a “key” into the organizational space for the registrant's social networking profiles, personal identity details set forth and access to the “hyperlinked” acknowledgments he or she has obtained. Registrant controls the level of access to the virtual wallet, specifically what information and which if not all of the social networking profiles added into the virtual wallet that each individual registrant scrutinizer of authenticity is allowed to access. The virtual wallet will be the only place that registrants should display personal information and that practice will be urged. Virtual wallets (and registrant profiles may be created and shared by family units or groups of people wishing to maintain privacy within their activities and communications but also seek to be recognized as their authentic profile (i.e. teens, siblings and parents or a family unit, members of a business entity or organization, or a group seeking privacy amongst themselves, etc. . . . ). In its essence, the virtual wallet is an organizational tool that supports this authentication method and is provided to every registrant along with the aforementioned social identity number.

To access the basic information of registrant, visitor or scrutinizer can just visit registrant's public page for cursory authentication scrutiny. For further scrutiny, (i.e. for online dating purposes or employment purposes, etc. . . . ), registrant may allow access to his or her virtual wallet (and thus more identification detail) when scrutinizer provides a name connected with the social identity number seeking to scrutinize his or her profile details. In short, scrutinizer must be invited to engage in detailed scrutiny by the registrant. By way of the social identity number, registrant controls scrutinizer access and amount of access to their virtual wallet unique to each registrant. In the virtual wallet, a scrutinizer may access the hyperlink of each of the third party social networking public pages placed into the wallet. Acknowledgments are also accessible in the virtual wallet by registrants invited and offered access to it. The acknowledgments will be “hyperlinked” within the virtual wallet to the acknowledger's public page where his or her basic information is displayed with their authenticity index factors. However, only in the virtual wallet, can those hyperlinks be clicked to access their destination. An acknowledger must register with the website to acknowledge the profiles, and these new registrants can now, in turn, populate their virtual wallet with their social networking profiles and solicit authenticity acknowledgments from their connections in each respective social network.

Finally, pursuant the same invite into the virtual wallet, the scrutinizer is allowed access to the detailed information going to the authenticity factors set forth in the authenticity index page so that the scrutinizer can conduct a self-determined evaluation of those factors in order to, among other things, determine the level of engagement that they seek to conduct with that party, determine behavior patterns registrant's data reveals when active in social networking, etc. . . . .

### Distinguishing Online Personal Social Networks from Online Professional Social Networks

Currently, there exists two vastly different online social networks. Professional networks and personal networks. This distinction is important to address since the issues confronting personal social networking profiles are unique to those profiles and differ from the issues encountered by those scrutinizing professional social networking profiles. Professional social network profiles are usually authenticated by the nature of their connections, by implication and scrutiny is generally relegated to verification of qualifications.

### Professional Networks:

Professional networks comprise of sites such as Branchout.com, LinkedIn.com, BizNik.com, Ryze.com, Networking for Professionals.com and Ecademy.com. These sites and their corresponding services focus on networking for business owners, entrepreneurs, employers and job seekers. People visiting these sites seek to network for jobs, business opportunities and to make business contacts. When people visit these sites the purpose is an investment in time. These sites generally seek verification related to professional qualifications of the subject or subject's qualifications derived from education, training and experience.

### Personal Networks:

Personal networks comprise of sites such as Facebook.com, MySpace.com, Google+ at Google.com, Twitter.com, Instagram com, Pinterest.com, the various online dating sites, etc. . . . . These sites focus on entertainment, socializing, staying in touch, sharing thoughts and pictures, romance, etc. . . . . People visit these sites to be entertained in the various forms offered. Here, there exists a casual mindset. And because of the ubiquity of the profiles set forth in these sites and the casual mindset, people create false profiles for reasons ranging from trivial to nefarious and criminal.

### The Solution Presented and Encompassed in this Invention

### The Uniqueness of the System

This system is not a rating, endorsement or fact gathering method of authentication. The present invention fills the existing void between a “Google”/“Yahoo” search engine based scrutiny of a person's name or online profile and a traditional background check offered by fact gathering websites such as BeenVerified.com by introducing an interactive platform for authentication.

One or more aspects of the system having advantages over a rating system, is that a rating system is subject to the limitations of a centralized based arbitrary scoring system of subjective factors where a system allowing determination of authenticity solely by the registrant or visiting scrutinizer is not subject to those limitations. This present system embodies in the fourth claim an “authenticity index”. This authenticity index provides a point of reference for the user's own determination of authenticity based on among other factors, personal preferences and experience (for example, to some users, an acknowledgement from a pastor, rabbi, cleric or a teacher, accomplished student, or popular person may carry more weight or “social currency” than other acknowledgements, depending on preference or experience). This human factor cannot effectively be taken into a verifiable measure by an algorithm based on a centralized predetermined score or rating because persons engaged in personal social networking know their connections intimately and their preferences differ. This system is based on the scrutinizing party's own determination of authenticity based on the level and type of engagement they seek, whether the engagement is for possible romance, a possible new personal social network connection, a transaction from online classified ads, etc. . . . .

This acknowledgements system is wholly different than an endorsement based system that is implemented in online professional networks. “Endorsements” and “acknowledgments” are separate and distinct legal terms of art. By definition, an endorsement conveys a commercial approval and judgment, such as a recommendation for financial compensation (http://www.merriam-webster.com/dictionary/endorse). As commonly used in the business realm, an endorsement conveys a recommendation or referral or even a signature on a check, bill or note. It is a very commercial term appropriate for professional networks. A verification method designed around endorsements is ideal for verification of professional or job qualifications such as education and experience. However, it is limited in evaluating authenticity of a profile as a whole or verifying the veracity of the online profile in the context of reconciliation with the real life personal attributes of the person behind the profile. This is so because an acknowledgment has much more of a generic application and is more of a recognition or avowal (http://www.merriam-webster.com/dictionary/acknowledgment) of readily observable data. Black's Law Dictionary defines the term acknowledge as a recognition of something as being factual, and has no commercial connotation listed (Black's Law Dictionary (2nd Pocket Ed., West 2001)).

Thus, generally, an acknowledgment addresses directly observable information comprising of personal attributes such, weight, hair color, skin color, style, etc. . . . along with personal information of the registrant they are aware of, such as relationship status, geographic location, age, common connections, etc. . . . . This set of information necessary for authentication of personal profiles is either inappropriate or (should be) irrelevant for endorsement of professional qualifications. Therefore, since issues confronting social networks are different, the solution to the issues must be designed accordingly.

### Operation of the Solution

### The System

### Specific Description of Invention/System

The present invention comprises of an “App” as defined above in the “General Summary”, that provides a unique peer based decentralized, online profile authentication method prominently utilizing the acknowledgement system whereby the scrutinizing party conducts a self-determined authenticity test dependent on the level of real engagement sought.

### CITATION LIST

U.S. Patents

| Pat. No. | Kind Code | Issue Date | Patentee |
|---|---|---|---|
| 8,010,460 | A1 | 2011-08-30 | Work, et al. |
| 8,010,459 | A1 | 2011-08-30 | Buyukkokten et al. |

### NonPatent Literature Documents

Seigneur, Jean-Marc Seigneur; Gray. Alan; and Damsgaard Jensen, Christian, (http://www.springerlink.com/openurl.asp?genre=article&id=doi:10.1007/11429760_{—}22) “Trust Transfer: Encouraging Self-Recommendations without Sybil Attack” (May 2005)
Douceur R., John (http://research.microsoft.com/en-us/people/johndo/publications.aspx) Proceedings' of 1st International Workshop on Peer-to-Peer Systems (IPTPS) “The Sybil Attack” (2002)

### ABSTRACT

### Technical Preliminary Visual of the Method and System of the Invention

This present acknowledgment based invention utilizes “indirect authentication” as opposed to direct authentication. There exist many systems in direct authentication where the subject profile is queried to a central authority for authentication. These systems are based on formulated algorithms limited to scrutiny from the central authority. The invention here addresses false profiles confronting online personal social networking systems via an indirect authentication system that relies on previously accepted profiles which in turn acknowledge the authentication of the remote profile under scrutiny.

This comprises the core of this decentralized, “peer to peer” based method of authentication. It is effective because users engaged in online personal social networking intimately know their unique social network. Users may “friend” or connect to a profile, but will be hesitant to “acknowledge” the veracity of a personal profile unless they are comfortable with certain level of knowledge or intimacy with that person and their profile. This is the “human factor” of experience that cannot be replicated by any centralized algorithm of any current level of attainable sophistication.

In operation, the system allows member users or registrants to create a profile, obtain a social identity code for privacy when engaged in public social networking as a public identifier. The system also integrates a virtual wallet to collect and synthesize all of their online profiles created and the registrant controls access to his or her virtual wallet by any other third party. The user will then offer the profile created and/or those profiles contained in the virtual wallet to be acknowledged for by their “friends” or social connections. Once the profile is acknowledged for on the website, a hyperlink to the acknowledger's member profile will be created to the acknowledger's public page or screen for further scrutiny and cross referencing purposes for visitors or registrants. The user scrutinizing the profile can then make his/her own “gut check” determination of the veracity of the profile. The system will offer an “authenticity index” type of graph for users to base their own level of verification needs or satisfaction for each profile.

### DRAWINGS

The present invention is illustrated via example, and not limitation, in the attached Figures One (1); Two (2); and Three (3).

FIG. 1 is a schematic of the general process of the system and method as a whole.

FIG. 2 is an overview specific of the authentication and acknowledgment process.

FIG. 3 is an illustration of how the

### DETAILED DESCRIPTION OF DRAWINGS

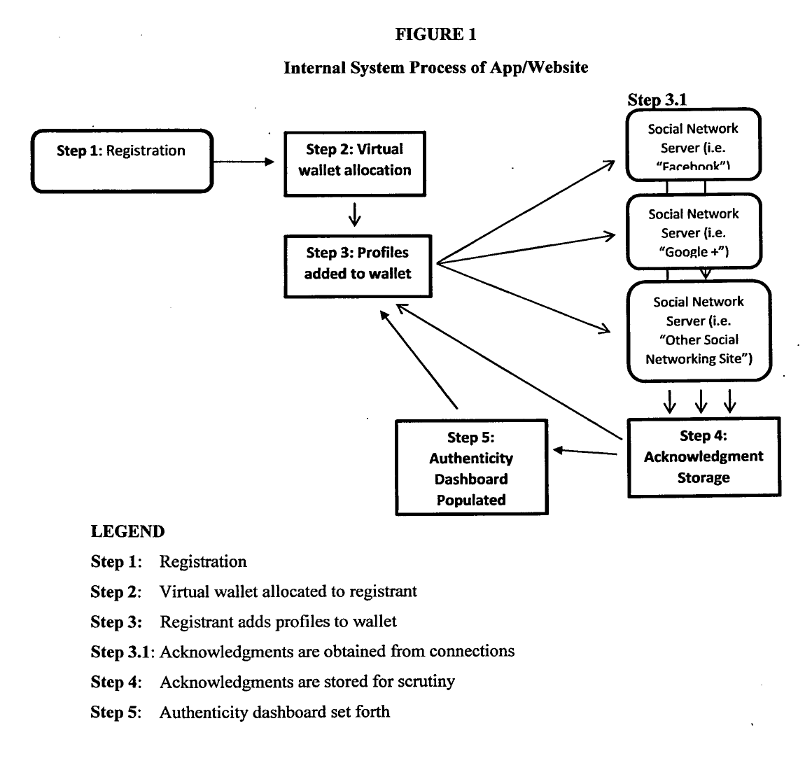

FIG. 1 is a schematic of the general step by step process of the invention. Step 1 is the starting point where members register, obtain the social identity code begin the authentication process by adding content to their account page(s). Step 2 illustrates the process the system engages in when allocating the components to registrant's new account or profile and spaces where the content is stored. Step 3 and 3.1 illustrates the process the servers engage when registrant adds social networking profiles into the virtual wallet page of their account, solicit acknowledgements from the connections in those profiles and how a connection acknowledges the account profiles and its contents. Step 4 illustrates the subsequent process of acknowledgment functions, storage and display in registrant's account. Step 5 depicts how the authenticity index may be set forth offering the authentication factors and metrics devices utilized by a scrutinizer to conduct a self-determined authentication analysis of those factors for whatever level of engagement with the registrant scrutinizer seeks.

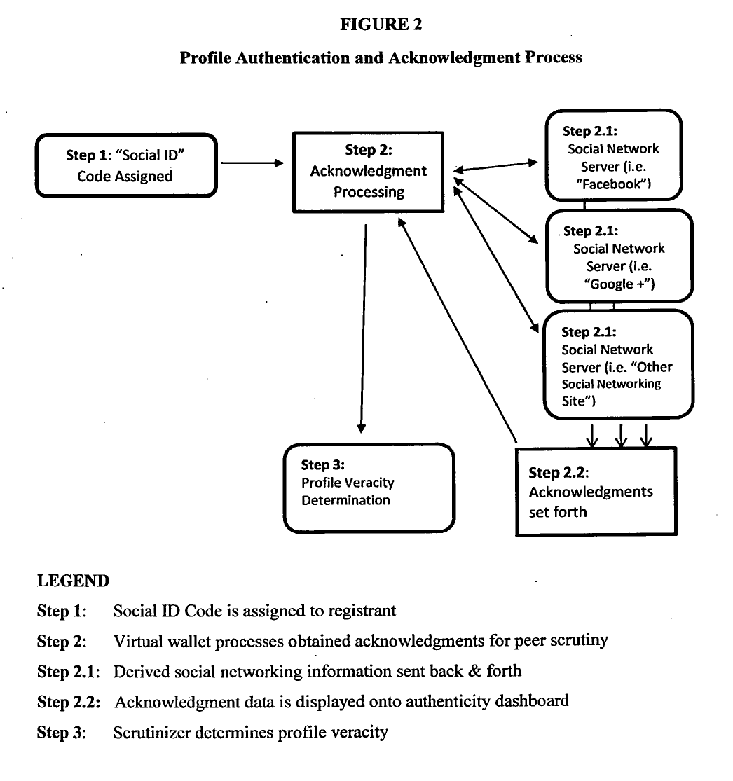

FIG. 2 is a schematic specific to the acknowledgment and authentication process of the system. Step 1 provides an illustration of the process a registrant goes through when adding content in the form of social networking profiles into the virtual wallet space of his account and then solicits the connections he or she has for acknowledgment of the authenticity of registrant's account profile. Steps 2, 2.1 and 2.2 illustrate the process the websites internal servers and the remote third party social network servers engage in when registrant acquires acknowledgments and how that information is sent forth, retrieved and processed back into his or her account profile. These steps also depict where the acknowledgments are stored and how those storage components interact with public visitors or member registrants invited to scrutinize the account. Step 3 then illustrates how the authentication factors may be set forth in the authenticity index and since this system is not based on a predetermined score or rating, how the scrutinizer can best and most efficiently conduct a determination of authenticity utilizing those factors set forth, customized to the level of authentication he or she seeks. This self-judgment, based on the facts provided by the authenticity factors in light of the need for authentication, allows the scrutinizer to quickly arrive at a decision and gives the scrutinizer a gut feel for the amount of risk entailed in a decision to engage with the person behind the profile.

It is expected that this self-examination will be more meaningful and of greater benefit to the scrutinizer than an analytical authentication system which attempts to score or rate authenticity, and recommends decisions based on a predetermined score or rating criteria.

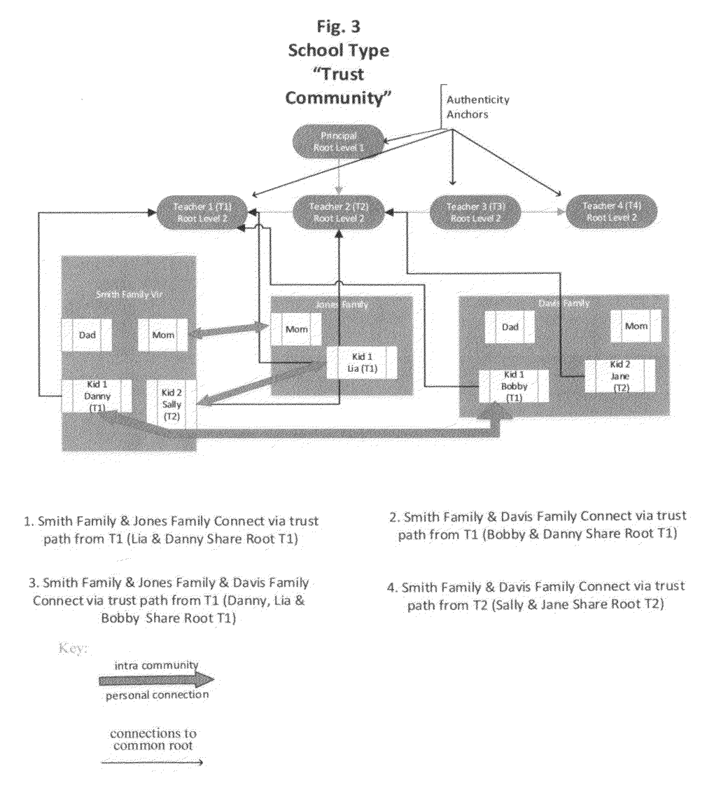

FIG. 3 is a schematic illustrating how the “authenticity anchors” work serving as a base for creating the more secure type of community—a “root trust community” ideal for school kids and parents. The units within the community depicted will ideally link (and allow private networking between) school children based on the trusted authenticity of the anchors (here a principal and shared teachers).

### CLAIMS

In its most basic description, the concept disclosed here comprises of all online individual software program application and supporting website (hereinafter, collectively referred to as “app”) operating through computerized devices accessing the world-wide web or internet which provides internet users engaged in various online activities a peer based or decentralized and effective pseudonym identity system to scrutinize and verify and measure online personal networking profiles for their reliability as the leading profiles utilized by that person engaging in that network.

What is claimed is:

1. A computer implemented method for a pseudonym identification system incorporating peer acknowledgment of online profiles set forth and derived from social networking systems into a private unique identity in the form of a pseudonym assigned to particular registrant whereby registrant may create a verification platform for the created pseudonym using said computer device.

2. The method of claim 1 wherein a unique identity is provided for each registrant, wherein said system utilizes a social identity code in the form of a pseudonym assigned to each registrant as an anonymous and private means of identification and consolidation of the derived online social networking profiles.

3. The method of claim 1 wherein this unique identity of the registrant is displayed in the form of an identifying social id, “plate”, card, avatar or other “landing screen”, home page identifiers setting forth metrics, aggregate totals, credential “tokens” or other calculators that calculate the aggregate of reliability factors such as, but not limited to, hours of human labor, authentication factors, biometric input, documentable and calculable interactions and other factors attributed to the registrant's use of the social networking profiles the system has derived information from, stored and allocated to the registrant's pseudonym identity.

4. The method of claim 1 wherein a registrant seeks acknowledgments, that may be hyperlinked, from peers within the system or within a derived social network as a means to vouch for the veracity of registrant's profile itself or of the content within the profile set forth to the potential acknowledger whereby the registrant sets forth, among other things, a verifiable method of scrutinizing connections and a calculation of the amount of potential human labor necessary to create a profile that includes those peer acknowledgments.

5. The method of claim 1, wherein system provides a platform for registrant to utilize a query search that accesses the system's own database server of registrants compiled within said system or the system's access to social networking databases to seek invitations into the discovered profiles for scrutiny of availed content, for, among other things, to gauge the veracity of the content itself, or to take content into account as a factor towards the amount of human labor necessary to create that profile as a measure of reliability of that profile being a primary vested profile for social networking and other online activity.

6. The method of claim 1, wherein said system utilizes an electronic storage unit compiled in the server in each registrant's account similar to a “virtual wallet” for electronic objects such as, but not limited to, links to the derived social networking profiles, hyperlinked acknowledgments, personal and biometric information, tagged photographs and other interactive activities, electronic sub-storage units containing information such as which communities registrant belongs to, so that another invited registrant may wish to scrutinize, vouch or verify;

7. The method of claim 1, wherein the internal portion of a registrant's account, the system compiles the acknowledgements and other authentication factors into a display screen or page operating as an authenticity index, whereby visitors or registrants conduct a determination of the authenticity of profile created or derived into said account and conclude for themselves whether the registrant's online profile(s) under scrutiny matches the real-life attributes or whether the profile is a primary profile of the registrant utilizing that registrant pseudonym.

8. The method of claim 1, wherein said system's trust and reliability can be enhanced by the platform embedded in system allowing registrants to create communities, enter and participate in root based integrated pseudonym identity communities based on authenticity anchors, which are deemed anchors either because they are chronologically superior, have been set forth as authenticity anchors by appointment or vote of other anchors or are self-appointed as anchors because the registrant anchor was instrumental in creating the community.
